(19) United States
(12) Patent Application Publication
(10) Pub. No.: US 2021/0396645 A1
(43) Pub. Date: Dec. 23, 2021

(54) Analyzer and Analysis Method

(71) Applicant: Shimadzu Corporation, Kyoto (JP)

(72) Inventors: Toru YAMAGUCHI, Kyoto (JP); Masahiro IHARA, Kyoto (JP)

(21) Appl. No.: 17/185,373

(22) Filed: Feb. 25, 2021

(30) Foreign Application Priority Data
Jun. 19, 2020 (JP) 2020-105789

(51) Int. Cl. G01N 15/14

(52) U.S. Cl. CPC G01N 15/1434; G01N 2015/1493

(57) ABSTRACT

An analyzer includes a flow channel through which a particle flows through, a particle image analysis device, a scattering amplitude measurement device, and an data generator. The particle image analysis device includes an imaging unit which captures an image of the particle flowing through the flow channel, a first acquisition unit the image which obtains a size of the particle captured in the image. The scattering amplitude measurement device includes: a laser light source which emits laser light to the flow channel; a photodetector which detects transmitted light and scattered light caused by the particle; and a second acquisition unit which obtains a complex scattering amplitude of the particle based on changes over time in interference between the transmitted light and the scattered light. Using the obtained size and complex scattering amplitude, the data generator generates characteristics data for the particle.

### BACKGROUND OF THE INVENTION

### Field of the Invention

The present invention relates to an analyzer and an analysis method.

### Description of the Background Art

In various fields of research and development, such as environmental, industrial, and biomedical fields, accurate analysis of characteristics of the particles is required.

In recent years, a technique for measuring the complex scattering amplitude of a single particle is proposed as a technique for analyzing such characteristics of the particles. For example, U.S. Patent Application Publication No. 2010/0141945 discloses a single particle extinction and scattering (SPES) method. The SPES method is a technique which detects interference between scattered light and transmitted light, which scattered light and transmitted light are caused by emitting laser light to a single particle, and calculates a complex scattering amplitude of the particle from a result of the detection. The SPES method is disclosed also in “Marco A. C. Potenza, and two others, ‘Measuring the complex field scattered by single submicron particles,’ AIP ADVANCES 5, 117222, 2015” and “Nobuhiro Moteki, ‘Capabilities and limitations of the single-particle extinction and scattering method for estimating the complex refractive index and size-distribution of spherical and non-spherical submicron particles,’ Journal of Quantitative Spectroscopy & Radiative Transfer, 243, 2020, 106811.”

### SUMMARY OF THE INVENTION

The complex scattering amplitude depends on the particle size and the complex refractive index of the particle. Therefore, the complex refractive index can be calculated from the complex scattering amplitude by assuming the particle size. However, due to the particle size being assumed, the accuracy of the calculated complex refractive index depends on a difference between the assumed size and the actual size of the particle. Accordingly, reduced accuracy of the calculated complex refractive index can result.

An object of the present disclosure is to provide an analyzer and an analysis method which can analyze characteristics of a particle with accuracy.

An analyzer according to a first aspect of the present invention analyzes characteristics of a particle. The analyzer includes: a flow channel through which the particle flows; a particle image analysis device; a scattering amplitude measurement device; and a data generator. The particle image analysis device includes: an imaging unit that captures an image of the particle flowing through the flow channel; and a first acquisition unit which obtains, based on the image, a size of the particle captured in the image. The scattering amplitude measurement device includes: a laser light source which emits laser light to the flow channel; a photodetector which detects transmitted light, which is a portion of the laser light which has been transmitted through the flow channel, and scattered light caused by the particle flowing through the flow channel; and a second acquisition unit which obtains a complex scattering amplitude of the particle flowing through the flow channel, based on changes over time in interference between the transmitted light and the scattered light. The data generator generates characteristics data, using the size of the particle obtained by the first acquisition unit and the complex scattering amplitude of the particle obtained by the second acquisition unit, the characteristics data including at least one of: a complex refractive index of the particle; a complex dielectric constant of the particle; and any data derived from the complex refractive index or the complex dielectric constant.

An analysis method according to a second aspect of the present invention analyzes characteristics of a particle. The analysis method includes: capturing an image of the particle flowing through a flow channel; obtaining, based on the image, a size of the particle captured in the image; emitting laser light to the flow channel; detecting transmitted light, which is a portion of the laser light which has been transmitted through the flow channel, and scattered light caused by the particle flowing through the flow channel; obtaining a complex scattering amplitude of the particle flowing through the flow channel, based on changes over time in interference between the transmitted light and the scattered light; and generating characteristics data, using the obtained size and the obtained complex scattering amplitude, the characteristics data including at least one of: a complex refractive index of the particle; a complex dielectric constant of the particle; and any data that is derived from the complex refractive index or the complex dielectric constant.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic view showing a configuration of a measurement device according to Comparative Example.

FIG. 2 is a diagram illustrating one example relationship of values of parameters A, U, obtained from outputs of a photodetector (the vertical axis), versus a particle position ζ (the horizontal axis).

FIG. 3 is a diagram illustrating one example of a complex scattering amplitude S.

FIG. 4 is a diagram showing another example of the complex scattering amplitude S.

FIG. 5 is a diagram showing an example process of estimation of the complex refractive index of a particle from a result of measurement of the complex scattering amplitude of the particle.

FIG. 6 is a diagram showing complex scattering amplitudes S calculated for particles which have different complex refractive indexes and sizes (particle size).

FIG. 7 is a schematic view showing a configuration of an analyzer according to Embodiment 1.

FIG. 8 is a schematic view showing a detailed configuration example of a particle image analysis device 20.

FIG. 9 is a diagram illustrating one example of a process performed by an acquisition unit 25 included in the particle image analysis device 20.

FIG. 10 is a flowchart showing a flow of an analysis method implemented by the analyzer according to Embodiment 1.

FIG. 11 is a schematic view showing a configuration of an analyzer according to Embodiment 2.

FIG. 12 is a schematic view showing a configuration of an analyzer according to Embodiment 3.

### DESCRIPTION OF THE PREFERRED EMBODIMENTS

### Comparative Example

Before describing embodiments according to the present disclosure, Comparative Example and its problems are now discussed. FIG. 1 is a schematic view showing a configuration of a measurement device according to Comparative Example. A measurement device 100 shown in FIG. 1 measures the complex scattering amplitude of a single particle, using a single particle extinction and scattering (SPES) method.

Measurement device 100 measures the complex scattering amplitude of a particle 60 flowing through a flow cell 200. The flow cell 200 comprises a light-transmissive material, such as a quartz, for example. A flow channel 201 is formed in the flow cell 200, through which a liquid sample containing the particle 60 to be measured is allowed to flow. In the following, a direction in which the flow channel 201 extends will be referred to as X axis, and a direction of travel of the liquid sample through the flow channel 201 will be referred to as the positive direction of X axis.

Measurement device 100 includes a laser light source 101, a collecting lens 102, and a photodetector 103.

The laser light source 101 emits laser light having a Gaussian intensity profile. The laser light source 101 is disposed so that the direction of propagation of the laser light intersects with the flow channel 201. In other words, where the optical axis of the laser light emitted by the laser light source 101 is Z axis, Z axis intersects with X axis. In the example shown in FIG. 1, Z axis is orthogonal to X axis. The direction of propagation of the laser light is the positive direction of Z axis.

The laser light emitted by the laser light source 101 is linearly polarized light. The direction of vibration of the electric field of the laser light intersects with the direction of propagation of the laser light and the flow channel 201. In the example shown in FIG. 1, the direction of vibration of the electric field of the laser light is in parallel with Y axis that is orthogonal to X and Z axes.

The collecting lens 102 is disposed between the laser light source 101 and the flow cell 200. The collecting lens 102 focuses the laser light, emitted by the laser light source 101, onto a region 202 of the flow channel 201. The collecting lens 102 is disposed so that the region 202 coincides with the beam waist location.

The photodetector 103 is opposite the laser light source 101 with respect to the flow cell 200, and is on the optical axis of the laser light emitted by the laser light source 101. The photodetector 103 detects (i) transmitted light, which is a portion of the laser light emitted by the laser light source 101 which has been transmitted through the flow channel 201, and (ii) scattered light caused by the particle 60 flowing through the flow channel 201.

The photodetector 103 has four light receiving elements 104, 105, 106, and 107. The light receiving elements 104 to 107 are each configured of a photodiode, for example. Typically, the photodetector 103 is a quadrant photodiode.

The light receiving elements 104 to 107 are disposed, surrounding the optical axis of the laser light (Z axis in FIG. 1). Specifically, the light receiving elements 104, 106 are disposed plane symmetric to each other with respect to a plane 70. The plane 70 includes Z axis, which is the optical axis of the laser light, and is orthogonal to the direction in which the flow channel 201 extends (X axis). The light receiving elements 105, 107 are also disposed plane symmetric to each other with respect to the plane 70. The light receiving elements 104, 105 are disposed plane symmetric to each other with respect to a plane 72. The plane 72 includes Z axis, which is the optical axis of the laser light, and is in parallel with the direction in which the flow channel 201 extends (X-axis direction). The light receiving elements 106, 107 are also disposed plane symmetric to each other with respect to the plane 72. In other words, the light receiving element 104 is disposed in an area of the photodetector 103 that is defined by the negative direction of X axis and the negative direction of Y axis with respect to Z axis. The light receiving element 105 is disposed in an area of the photodetector 103 that is defined by the negative direction of X axis and the positive direction of Y axis with respect to Z axis. The light receiving element 106 is disposed in an area of the photodetector 103 that is defined by the positive direction of X axis and the negative direction of Y axis with respect to Z axis. The light receiving element 107 is disposed in an area of the photodetector 103 that is defined by the positive direction of X axis and the positive direction of Y axis with respect to Z axis.

Measurement device 100 measures the complex scattering amplitude of the particle 60 based on changes over time in interference between the transmitted light and the scattered light. Specifically, using respective outputs Pa to Pd of the light receiving elements 104 to 107, measurement device 100 measures the complex scattering amplitude of the particle 60 passing through the region 202 of the flow channel 201.

Measurement device 100 measures changes over time in parameters A, U, which changes are associated with the particle 60 passing through the region 202. The parameters A, U are defined by Equations (1), (2), respectively, below. In Equation (1), Ptot is a total sum of outputs Pa to Pd. In Equations (1), (2), Pref is Ptot when the particle 60 is not present in the region 202. Pref is experimentally predetermined, for example, and set by measurement device 100. The parameter A indicates a value obtained by normalizing the total sum of outputs Pa to Pd by Pref. The parameter U indicates a value obtained by normalizing by Pref a difference between the sum of outputs Pa, Pb and the sum of outputs Pc, Pd. The parameters A, U indicate the interference between the transmitted light and the scattered light.

$$[ MATH 1 ]$$

$$\begin{matrix}A = \frac{( Ptot - Pref )}{Pref} & Equation ( 1 ) \\ U = \frac{( Pa + Pb ) - ( Pc + Pd )}{Pref} & Equation ( 2 )\end{matrix}$$

Changes A(t), U(t) over time in parameters A, U are, respectively, represented by Theoretical Equations (3), (4):

$$[ MATH 2 ] \begin{matrix}A ( t ) = - 2 {( \frac{λ}{π {ω}_{0}} )}^{2} {e}^{- 2 {ξ}^{2} ( t )} \vert S \vert sin φ & Equation ( 3 ) \\ U ( t ) = 2 {( \frac{λ}{π {ω}_{0}} )}^{2} {e}^{- 2 {ξ}^{2} ( t )} erfi ξ ( t ) \vert S \vert cos φ & Equation ( 4 )\end{matrix}$$

where λ is a wavelength of the laser light; ω₀ is a beam waist radius; ζ(t) is a particle position on X axis a time t; the particle position being obtained by normalizing by the beam waist radius; erfi is an imaginary error function; S is a complex scattering amplitude; and φ is a phase difference of a scattered field from an incident E-field.

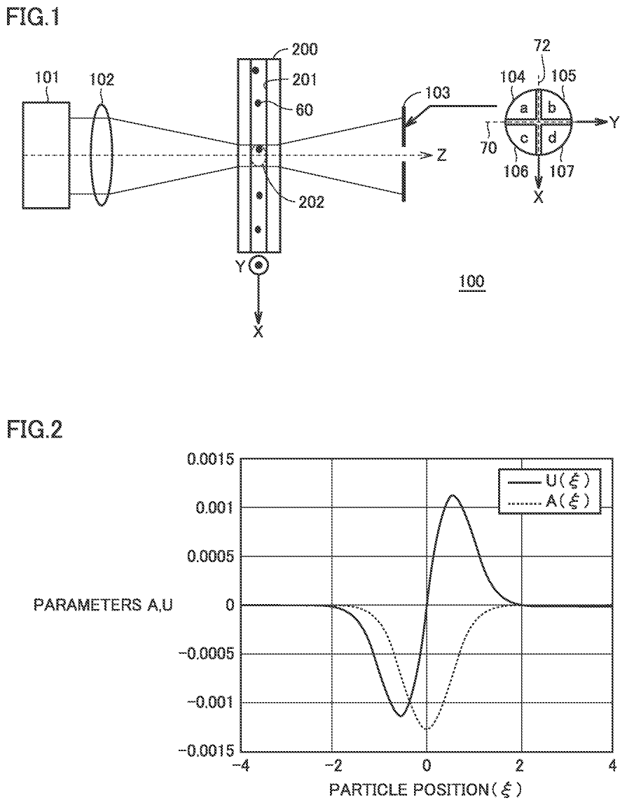

FIG. 2 is a diagram illustrating one example relationship of values of the parameters A, U, obtained from outputs of the photodetector (the vertical axis), versus a particle position (the horizontal axis). The particle position is one on X axis and normalized by the beam waist radius. The solid line indicates the parameter U. The dotted line indicates the parameter A. FIG. 2 shows the relationship of the parameters A, U versus the particle position when the wavelength λ=0.6328 μm, the beam waist radius ω₀=5.0 μm, the complex scattering amplitude intensity |S|=1.0, and the phase difference φ=0.4. As shown in FIG. 2, as the particle 60 moves in X-axis direction along the flow channel 201, the values of the parameters A, U depend on the particle position.

An incident E-field Einc,y, which propagates in the positive direction of Z axis and vibrates in Y-axis direction, and a scattered field Esca,y which is created from a scatterer at the coordinate origin and present on Z axis a range r away from the origin, satisfy the following Equation (5), using the complex scattering amplitude S:

$$[ MATH 3 ]$$

$${E}_{sca , y} = \frac{{e}^{ikr}}{r} {SE}_{inc , y} \qquad Equation ( 5 )$$

where k is a wave number of the laser light. Using |S| and φ included in the Theoretical Equations (3), (4) above, the complex scattering amplitude S is represented by Equation (6):

[MATH 4]

S=|S|e^{iφ} Equation (6)

Therefore, measurement device 100 can calculate the complex scattering amplitude S, using the minimal value of changes A(t) over time in parameter A and the maximal and minimal values of changes U(t) over time in parameter U.

As disclosed in “Nobuhiro Moteki, ‘Capabilities and limitations of the single-particle extinction and scattering method for estimating the complex refractive index and size-distribution of spherical and non-spherical submicron particles,’ Journal of Quantitative Spectroscopy & Radiative Transfer, 243, 2020, 106811,” the complex scattering amplitude S is, theoretically, represented by Equation (7):

$$[ MATH 5 ]$$

$$S = \frac{{k}^{2}}{4 π} v [ {( \frac{m}{{m}_{med}} )}^{2} - 1 ] F ( k , v , m / {m}_{med} , shape ) \qquad Equation ( 7 )$$

where v is the volume of the particle, which is a scatterer, m is the complex refractive index of the particle, m_{med} is the complex refractive index of a solvent, and F is a form factor of the particle. Thus, the complex scattering amplitude S depends on the volume of the particle, the complex refractive index of the particle, and the form factor of the particle. The complex scattering amplitude S can be calculated by numerical calculation by using the technique disclosed in “D. W. Mackowski et al., ‘A multiple sphere T-matrix Fortran code for use on parallel computer clusters,’ Journal of Quantitative Spectroscopy & Radiative Transfer, 112, p. 2182-2192, 2011” and “J. Leinonen, ‘High-level interface to T-matrix scattering calculations: architecture, capabilities and limitations,’ Optics Express, Vol. 22, No. 2, p. 1655-1660, 2014.”

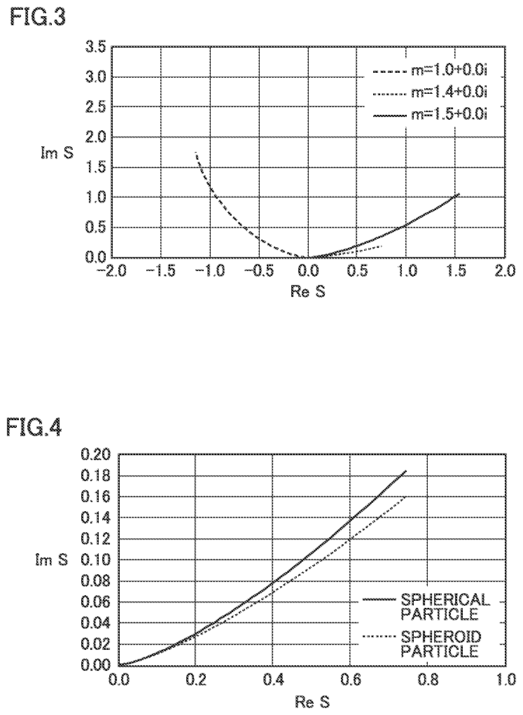

FIG. 3 is a diagram illustrating one example of the complex scattering amplitude S that is calculated using the technique disclosed in “D. W. Mackowski et al., ‘A multiple sphere T-matrix Fortran code for use on parallel computer clusters,’ Journal of Quantitative Spectroscopy & Radiative Transfer, 112, p. 2182-2192, 2011” and “J. Leinonen, ‘High-level interface to T-matrix scattering calculations: architecture, capabilities and limitations,’ Optics Express, Vol. 22, No. 2, p. 1655-1660, 2014.” FIG. 4 is a diagram showing another example of the complex scattering amplitude S that is calculated using the technique disclosed in “D. W. Mackowski et al., ‘A multiple sphere T-matrix Fortran code for use on parallel computer clusters,’ Journal of Quantitative Spectroscopy & Radiative Transfer, 112, p. 2182-2192, 2011” and “J. Leinonen, ‘High-level interface to T-matrix scattering calculations: architecture, capabilities and limitations,’ Optics Express, Vol. 22, No. 2, p. 1655-1660, 2014.” In FIGS. 3 and 4, the real part of the complex scattering amplitude S is indicated on the horizontal axis, and the imaginary part of the complex scattering amplitude S is indicated on the vertical axis.

FIG. 3 shows complex scattering amplitudes S of spherical particles having complex refractive indices m=1.0+0.0i, 1.4+0.0i, 1.5+0.0i with the dashed line, the dotted line, and the solid line, respectively. The dashed line, the dotted line, and the solid line of FIG. 3 indicate the complex scattering amplitudes S when the radius r of the particle is changed in a range of 0<r<0.5 μm, where the wavelength λ of the laser light is 0.6328 μm, the complex refractive index m_{med} of a solvent is 1.327+0.0i.

FIG. 4 shows complex scattering amplitudes S calculated for a spherical particle and a spheroid particle with the solid line and the dotted line, respectively. Note that a ratio (aspect ratio) of the minor axis and the major axis of the spheroid particle is 0.6. The solid line and the dotted line of FIG. 4 indicate the complex scattering amplitudes S when rv is changed in a range of 0<rv<0.5 μm, where rv is half the equivalent volume diameter (volume equivalent diameter) of the particle, the wavelength λ of the laser light is 0.6328 μm, the complex refractive index m_{med} of a solvent is 1.327+0.0i, and the complex refractive index m of the particle is 1.4+0.0i.

As shown in FIGS. 3 and 4, if the particle size has a distribution, the complex scattering amplitude S of the particle is plotted on a line corresponding to the complex refractive index m of the particle by knowing or assuming the particle shape. For this reason, the complex refractive index of the particle 60 can be estimated by plotting multiple complex scattering amplitudes S which are measured by measurement device 100 for multiple particles 60 of identical composition.

FIG. 5 is a diagram showing an example process of estimation of the complex refractive index of the particle from a result of measurement of the complex scattering amplitude of the particle. FIG. 5 shows a process of estimation of the complex refractive index of the particle 60, assuming that the particle 60 has a spherical shape.

As shown in FIG. 5, a scatter chart is created, in which the multiple complex scattering amplitudes S is plotted which are measured for multiple particles 60 of identical composition whose particle size is varied in CV value (coefficient of variation) of 3%. Next, a complex refractive index which gives the least error with the created scatter chart is calculated, using a regression calculation, for example. The calculated complex refractive index is estimated as the complex refractive index of the particle 60.

FIG. 5 shows the dashed line corresponding to a spherical particle having a complex refractive index m=1.5+0.0i. The error between the dashed line and the scatter chart is at minimum. Consequently the complex refractive index of the particle 60 is estimated to be 1.5+0.0i.

However, the above method requires acquisition of multiple complex scattering amplitudes S that are respectively measured for multiple particles 60 of identical composition. For this reason, the liquid sample flowing through the flow channel 201 contains multiple types of particles, and the complex refractive index of one type of particle among them cannot be estimated. For example, the complex refractive index of a foreign substance that has a small abundance ratio, or a contaminated particle cannot be estimated.

Furthermore, particles having different complex refractive indices and sizes (particle sizes) can exhibit a similar complex scattering amplitude S. Consequently, if the size is unknown, the complex refractive index of the particle 60 cannot be accurately estimated from the multiple complex scattering amplitudes S measured for multiple particles 60 of identical composition.

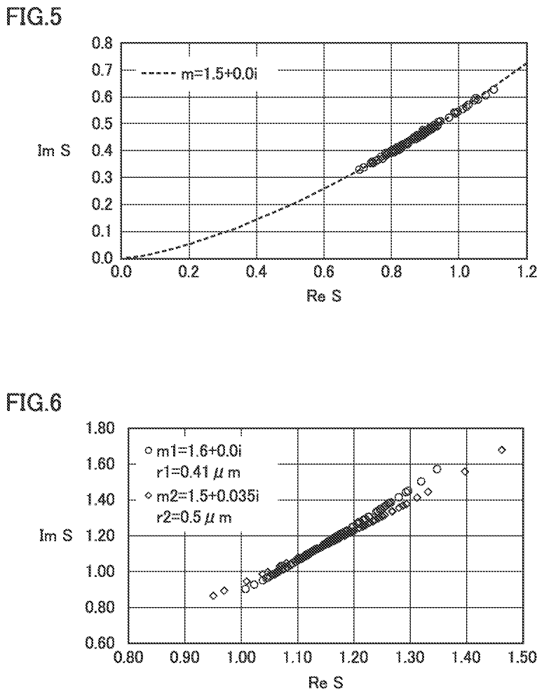

FIG. 6 is a diagram showing complex scattering amplitudes S calculated for particles which have different complex refractive indices and sizes (particle sizes). FIG. 6 shows complex scattering amplitudes S of multiple first particles (circles), and complex scattering amplitudes S of multiple second particles (diamonds). The first particles are spherical particles having a complex refractive index m1=1.6+0.0i. The first particles have particle sizes that vary in CV value of 3%, and have an average radius r1 of 0.41 μm. The second particles are spherical particles having a complex refractive index m2=1.5+0.035i. The second particles have particle sizes that vary in CV value of 3%, and have an average radius r2 of 0.50 μm. Note that the particle sizes of the first particles and second particles are calculated, where the wavelength λ of the laser light is 0.6328 μm and the complex refractive index m_{med} of a solvent is 1.327+0.0i.

As shown in FIG. 6, the complex scattering amplitudes S of the first particles and the complex scattering amplitudes S of the second particles substantially coincide with each other. For this reason, if the size of the particle 60 to be measured is unknown, the complex refractive index of the particle 60 cannot be accurately estimated. Alternatively, a classification process needs to be previously performed for accurate estimation of the complex refractive index of the particle 60.

An analyzer according to an embodiment shown below solves such a problem, and allows accurate analysis of characteristics of a particle, without requiring a classification process being performed prior to the analysis.

### Embodiment 1

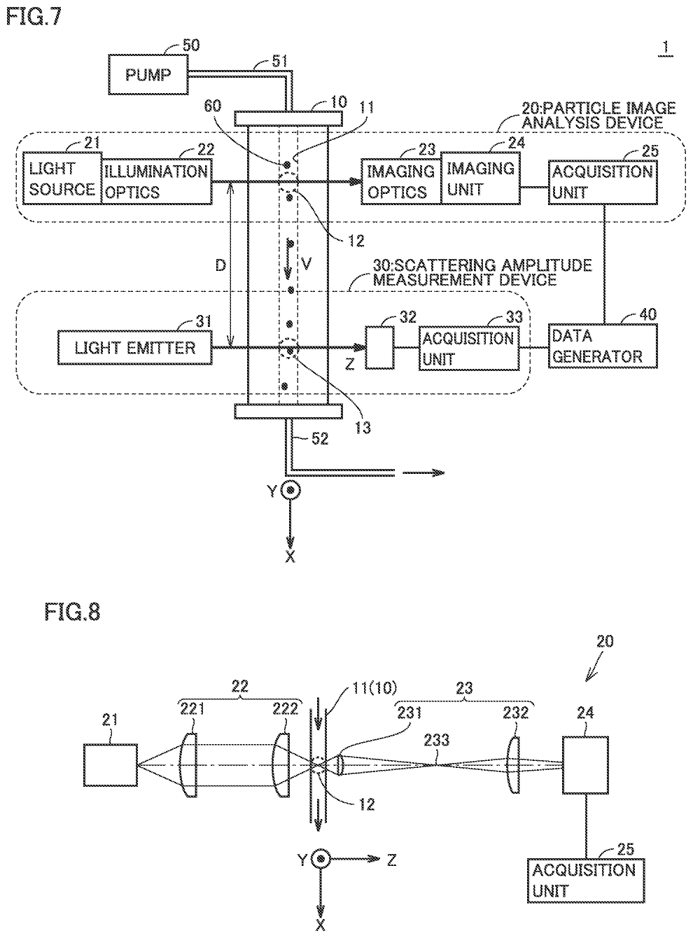

FIG. 7 is a schematic view showing a configuration of an analyzer according to Embodiment 1. As shown in FIG. 1, the analyzer 1 includes a transparent flow channel 11 through which a particle 60 to be analyzed flows, a particle image analysis device 20, a scattering amplitude measurement device 30, a data generator 40, and a pump 50.

(Flow Channel 11)

The flow channel 11 is formed of one flow cell 10. The flow cell 10 is configured of a light-transmissive material, such as a quartz, for example. The use of one flow cell 10 readily allows formation of the flow channel 11 that is linear and has a certain cross-sectional area, as shown in FIG. 1. In the example shown in FIG. 1, the direction in which the flow channel 11 extends coincides with the vertical direction. Hereinafter, the direction in which the flow channel 11 extends is referred to as X axis.

Pump 50 supplies a liquid sample, containing a particle 60 to be analyzed, into the flow cell 10 via a pipe 51 connecting the pump 50 and the flow cell 10. In the example shown in FIG. 1, the pump 50 supplies the liquid sample into the flow channel 11 through an upper end of the flow channel 11. For this reason, the liquid sample flows through the flow channel 11 in the vertically downward direction. The liquid sample, containing the particle 60, flows through the flow channel 11 at a flow velocity V corresponding to performance of the pump 50. A pipe 52 is connected to a lower end of the flow channel 11. The liquid sample passed through the flow channel 11 is discharged from the flow channel 11 through the pipe 52.

(Particle Image Analysis Device 20)

The particle image analysis device 20 captures an image of the particle 60 flowing through the flow channel 11, and analyzes the obtained image, and obtains analysis data. For example, “iSPECT DIA-10,” manufactured by Shimadzu Corporation, may be used as the particle image analysis device 20.

FIG. 8 is a schematic view showing a detailed configuration example of the particle image analysis device 20. As shown in FIGS. 7 and 8, the particle image analysis device 20 includes a light source 21, illumination optics 22, imaging optics 23, an imaging unit 24, and an acquisition unit 25.

The light source 21 is, for example, a flash lamp. The light source 21 emits pulsed light through the flow cell 10.

The illumination optics 22 are disposed between the light source 21 and the flow cell 10, and focus the light emitted by the light source 21 onto a region 12 of the flow channel 11. As shown in FIG. 8, the illumination optics 22 include, for example, a field lens 221, and a condenser lens 222. The field lens 221 is disposed facing the light source 21. The condenser lens 222 is disposed facing the flow cell 10. The imaging unit 24 is disposed downstream of the flow cell 10 in the direction in which the light is emitted. The imaging unit 24 is configured of, for example, a camera.

The imaging optics 23 are disposed between the flow cell 10 and the imaging unit 24. The imaging optics 23 project the light, transmitted through the flow cell 10, onto the imaging unit 24. As shown in FIG. 8, the imaging optics 23 include, for example, an objective lens 231, and a projection lens 232. The objective lens 231 is disposed facing the flow cell 10. The projection lens 232 is disposed facing the imaging unit 24.

The optical axes of the light source 21, the illumination optics 22, the imaging optics 23, and the imaging unit 24 intersect with X axis which is the direction in which the flow channel 11 extends. In the examples shown in FIGS. 7 and 8, the optical axes of the light source 21, the illumination optics 22, the imaging optics 23, and the imaging unit 24 are in parallel with Z axis that is orthogonal to X axis. Note that the optical axis of the imaging unit 24 passes through the center of a light-receiving plane in the imaging unit 24 and is in parallel with a normal direction of the light-receiving plane.

The light emitted by the light source 21 passes through the field lens 221 and is rendered parallel light, and further passes through the condenser lens 222 and is focused onto the region 12 within the flow channel 11. The light emitted to the liquid sample within the flow channel 11 passes through the objective lens 231 and is imaged at an image location 233, and further passes through the projection lens 232 and is projected onto the imaging unit 24.

The imaging unit 24 captures images of the light at regular intervals. The imaging unit 24 has a clock (not shown), adds first time data indicative of an imaging time to image data (Hereinafter, simply referred to as an “image.”) obtained by capturing an image of the light, and outputs the image data to the acquisition unit 25.

The liquid sample flowing through the flow channel 11 contains a low concentration of particles. For this reason, the images output from the imaging unit 24 also include an image in which no particle is captured.

The acquisition unit 25 can be configured of hardware, such as a circuit device that implements its functionality. Alternatively, the acquisition unit 25 may be configured of a processor, such as a central processing unit (CPU), and a memory storing software that is executed by the processor.

The acquisition unit 25 analyzes the image output from the imaging unit 24, and obtains analysis data indicative of a result of the analysis. The analysis data at least includes data on the size of the particle 60 captured in the image. The size data indicates, for example, a projected area circle equivalent diameter of the particle 60. Furthermore, the analysis data may include data on the shape of the particle 60 captured in the image. The shape data indicates, for example, either a spherical shape or a spheroid shape. Note that if the shape data indicates a spheroid shape, the size data indicates the major axial diameter and the minor axial diameter of the particle 60.

If the particle 60 is present in the region 12 of the flow channel 11, the amount of light transmission is reduced at the location where the particle 60 is present. Consequently, the brightness of the pixels showing the particle 60 in the image is lower than the brightness of the other pixels. For example, the acquisition unit 25 identically labels the pixels that have brightness less than a threshold, and identifies the labeled pixels as those showing the particle 60. Using a known image processing technology, the acquisition unit 25 may generate the size data and the shape data from the identified pixel region.

As described above, images output from the imaging unit 24 also include images in which no particle is captured. Thus, if a total number of pixels, whose brightness is less than the threshold, is included in an image less than a reference value, the acquisition unit 25 may determine that no particle is captured in the image, and discard the image.

The acquisition unit 25 stores the analysis data, which is obtained based on an image in which a particle is captured, and the first time data, added to the image, in association with each other.

(Scattering Amplitude Measurement Device 30)

As with the measurement device 100 shown in FIG. 1, the scattering amplitude measurement device 30 measures the complex scattering amplitude S of the particle 60 flowing through the flow channel 11. As shown in FIG. 7, the scattering amplitude measurement device 30 includes a light emitter 31, a photodetector 32, and an acquisition unit 33.

The light emitter 31 emits laser light to a region 13 of the flow channel 11. The region 13 is where the particle 60, whose complex scattering amplitude S is to be measured, passes through. The laser light has an optical axis intersecting with X axis which is the direction in which the flow channel 11 extends. In the example shown in FIG. 7, the optical axis of the laser light coincides with Z axis orthogonal to X axis.

The light emitter 31 is configured of the laser light source 101 and the collecting lens 102 shown in FIG. 1. However, the collecting lens 102 may be omitted if the majority of the laser light emitted by the laser light source 101 is directly incident on the region 13.

The photodetector 32 has the same configuration as the photodetector 103 shown in FIG. 1. In other words, the photodetector 32 is configured of a quadrant photodiode which includes four light receiving elements 104, 105, 106, 107. Therefore, detailed description of the photodetector 32 is omitted.

The acquisition unit 33 can be configured of hardware, such as a circuit device that implements its functionality. Alternatively, the acquisition unit 33 may be configured of a processor, such as a CPU, and a memory storing software that is executed by the processor.

The acquisition unit 33 obtains the complex scattering amplitude S of the particle 60 flowing through the flow channel 11, based on changes over time in interference between the transmitted light and the scattered light detected by the photodetector 32. Specifically, the acquisition unit 33 obtains the complex scattering amplitude S of the particle 60 passing through the region 13, based on changes A(t), U(t) over time in parameters A, U, which changes are calculated from four outputs Pa, Pb, Pc, Pd from the photodetector 32. The method of calculation of the complex scattering amplitude S is as described with Comparative Example above. In other words, in response to changes A(t), U(t) over time in parameters A, U exhibiting waveforms as shown in FIG. 2, the acquisition unit 33 calculates the complex scattering amplitude S of the particle 60, based on the minimal value of changes A(t) over time in parameter A and the maximal and minimal values of changes U(t) over time in parameter U.

The light emitter 31 is disposed so that the optical axis of the laser light passes through the center of the region 13. However, the particle 60 may not always pass through near or at the center of the region 13 in Y-axis direction. If the particle 60 passes through near an edge of the region 13 in Y-axis direction, the complex scattering amplitude S may not be accurately measured. Given this situation, the acquisition unit 33 may calculate a parameter U′ indicated by Equation (8) below, and calculate the complex scattering amplitude S only if the parameter U′ is less than a predetermined threshold.

$$[ MATH 6 ]$$

$${U}^{′} = \vert \frac{( Pa + Pc ) - ( Pb + Pd )}{Pref} \vert \qquad Equation ( 8 )$$

The acquisition unit 33 has a clock (not shown), and generates second time data indicative of a time indicative of the minimal value of changes A(t) over time in parameter A (or a time at which changes U(t) over time in parameter U is zero). Note that the clock included in the acquisition unit 33 is time synchronized with the clock included in the acquisition unit 25. The time indicated by the second time data corresponds to the time at which the particle 60 passes through the optical axis of the laser light. The acquisition unit 25 stores the complex scattering amplitude S calculated based on changes A(t), U(t) over time in parameters A, U, and the second time data generated based on the changes A(t) over time in parameter A (or the changes U(t) over time in parameter U), in association with each other.

(Information Generator 40)

The data generator 40 can be configured of hardware, such as a circuit device that implements its functionality. Alternatively, the data generator 40 may be configured of a processor, such as a CPU, and a memory storing software that is executed by the processor.

The data generator 40 generates characteristics data indicative of characteristics of the particle 60, using the analysis data obtained by the acquisition unit 25 and the complex scattering amplitude S obtained by the acquisition unit 33. In Embodiment 1, the data generator 40 generates characteristics data that includes the complex refractive index of a particle.

The data generator 40 extracts analysis data and complex scattering amplitude S of the same particle 60, from the analysis data stored in the acquisition unit 25 and the complex scattering amplitude S stored in the acquisition unit 33. The particle 60 flows through the flow channel 11 at the flow velocity V. A transit time t3 for the particle 60 between the region 12 and the region 13 is represented by t3=DN, where D is the distance from the region 12 to be imaged and the region 13 to which the laser light is emitted. The transit time t3 is pre-set to the data generator 40. As the analysis data and the complex scattering amplitude S of the same particle 60, the data generator 40 extracts analysis data and complex scattering amplitude S that are associated with the first time data indicative of a time t1 and the second time data indicative of a time t2, the time t1 and the time t2 satisfying Equation (9):

|t3−(t2 −t1)|<tdet Equation (9)

where tdet is a predetermined threshold.

The complex scattering amplitude S of the particle 60, the complex refractive index m of the particle 60, the volume v of the particle 60, and the form factor F of the particle 60 satisfy Equation (7) above. Consequently, the data generator 40 calculates the complex refractive index m of the particle 60, using the extracted analysis data and complex scattering amplitude S, and Equation (7).

Specifically, the data generator 40 calculates the volume v and the form factor F of the particle 60, based on the extracted analysis data. For example, if the particle 60 is known to be in a spherical shape, the data generator 40 may calculate the volume v and the form factor F of the particle 60, using the size (e.g., the projected area circle equivalent diameter) indicated by the analysis data. Alternatively, if the shape of the particle 60 is unknown, the data generator 40 may calculate the volume v and the form factor F of the particle 60, using the shape (spherical shape or spheroid shape) indicated by the shape data included in the analysis data, and the size (e.g., the projected area circle equivalent diameter, the major axial diameter, the minor axial diameter) indicated by the analysis data.

The data generator 40 assigns the calculated volume v and form factor F and the extracted complex scattering amplitude S to Equation (7) thereby calculating the complex refractive index m of the particle 60. Note that the data generator 40 stores the complex refractive index m_{med} of a solvent previously measured experimentally, and assigns this complex refractive index m_{med} to Equation (7).

In this manner, the data generator 40 can accurately analyze the complex refractive index m of the particle 60 by using not only the complex scattering amplitude S measured by the scattering amplitude measurement device 30, but also the size of the particle 60 obtained by the particle image analysis device 20.

Note that the orientation of the particle 60 can vary in the liquid sample. If the particle 60 has a spherical shape, changes in the orientation of the particle 60 has little effect on the obtained analysis data and complex scattering amplitude S. Consequently, the complex refractive index m of the particle 60 having a spherical shape can be accurately analyzed.

If the particle 60 has a spheroid shape, on the other hand, as changes in orientation of the particle 60 changes the obtained analysis data and complex scattering amplitude S. However, in Embodiment 1, the flow channel 11 is linear and has a certain cross-sectional area. Therefore, the particle 60 is allowed to move from the region 12 to the region 13 while keeping the orientation of the particle 60 constant, by appropriately adjusting, for example, the viscosity of the solvent included in the liquid sample. Furthermore, the optical axis of the imaging unit 24 is in parallel with the optical axis of the laser light (Z axis). This allows the analysis data and the complex scattering amplitudes S of particles 60 having the same orientation to be obtained even if the particles 60 have a spheroid shape. As a result, the complex refractive index m of the particle 60 can be accurately analyzed.

(Example Processing by Acquisition Unit 25)

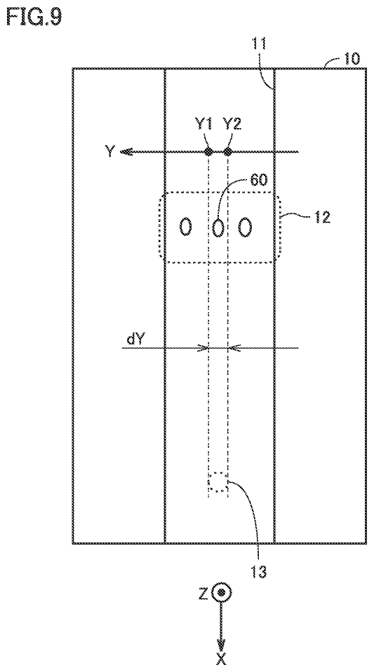

FIG. 9 is a diagram illustrating one example of the process performed by the acquisition unit 25 included in the particle image analysis device 20. FIG. 9 shows the flow channel 11 as viewed in Z-axis direction. As shown in FIG. 9, the length in Y-axis direction of the region 12 to be imaged by the imaging unit 24 is greater than the length of the flow channel 11 in Y-axis direction. Note that Y axis is orthogonal to both the direction in which the flow channel 11 extends (X axis), and Z axis which is the optical axis of the laser light, as described above.

In contrast, a length dY in Y-axis direction of the region 13, through which the particle 60 whose complex scattering amplitude is to be measured by the scattering amplitude measurement device 30 passes through, is less than the length of the flow channel 11 in Y-axis direction. The length dY depends on the beam waist radius Wo. Furthermore, if a comparison process is performed between the parameter U′ indicated by Equation (8) above and the threshold, the length dY depends also on that threshold. As such, the acquisition unit 33 included in the scattering amplitude measurement device 30 obtains the complex scattering amplitude of the particle 60 flowing through the flow channel 11 within a target range having the length dY on Y axis (Y1<Y<Y2).

The acquisition unit 25 included in the particle image analysis device 20 may obtain the analysis data on the particle 60 that is captured in a portion of the image obtained by the imaging unit 24, the portion corresponding to the above target range (Y1<Y<Y2). This generates, even if multiple particles 60 are present in the region 12, analysis data on the particle 60 flowing through within the target range (i.e., the particle 60 whose complex scattering amplitude S is to be measured), as shown in FIG. 9.

(Analysis Method Flow)

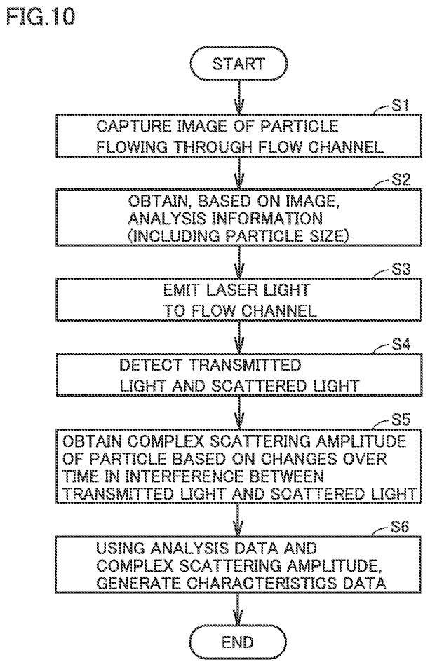

FIG. 10 is a flowchart showing a flow of the analysis method implemented by the analyzer according to Embodiment 1.

As shown in FIG. 10, the imaging unit 24 captures an image of the particle 60 flowing through the transparent flow channel 11 (step S1). Next, the acquisition unit 25 obtains, based on the image, analysis data on the particle 60 captured in the image (step S2). The analysis data includes at least the size of the particle 60.

Next, the light emitter 31 emits laser light to the flow channel 11 (step S3). Next, the photodetector 32 detects transmitted light, which is a portion of the laser light which has been transmitted through the flow channel 11, and scattered light caused by the particle 60 flowing through the flow channel 11 (step S4). Next, the acquisition unit 33 obtains the complex scattering amplitude S of the particle 60 flowing through the flow channel 11, based on changes over time in interference between the transmitted light and the scattered light (step S5).

Next, using the obtained analysis data and complex scattering amplitude S, the data generator 40 generates characteristics data which includes the complex refractive index of the particle 60 (step S6).

### Embodiment 2

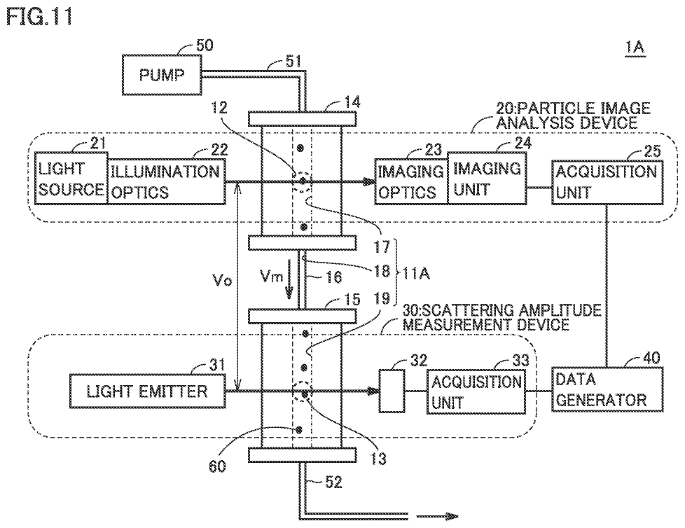

FIG. 11 is a schematic view showing a configuration of an analyzer according to Embodiment 2. As shown in FIG. 11, an analyzer 1A according to Embodiment 2 is the same as the analyzer 1 shown in FIG. 7, except for including a flow channel 11A, instead of the flow channel 11.

The flow channel 11A is formed of two flow cells 14, 15 and a pipe 16 connecting the flow cells 14, 15. In other words, the flow channel 11A includes a flow channel 17 formed within the flow cell 14, a flow channel 18 within the pipe 16, and a flow channel 19 formed within the flow cell 15. A region 12 to be imaged by the imaging unit 24 is located in the flow channel 17. A region 13, to which the laser light is emitted, is located in the flow channel 19.

If the flow channels 17, 18 have different cross-sectional areas, a turbulent flow is caused in the liquid sample at the point of connection between the flow channels 17, 18. If the flow channel 18, 19 have different cross-sectional areas, a turbulent flow is caused in the liquid sample at the point of connection between the flow channels 18, 19. Due to these turbulent flows, the orientation of the particle 60 changes while the particle 60 is moving from the region 12 to the region 13. As described above, if the particle 60 has a spherical shape, changes in the orientation of the particle 60 has little effect on the obtained analysis data and complex scattering amplitude S. Therefore, the analyzer 1A according to Embodiment 2 is applicable to the particle 60 having a spherical shape.

Note that if the flow channels 17, 18 have different cross-sectional areas, the flow velocities in the flow channels 17, 18 are different too. Therefore, the transit time t3 is determined by t3=Vo/Vm, using a capacity Vo between the region 12 and the region 13, and a flow rate Vm in the flow channel 11A.

### Embodiment 3

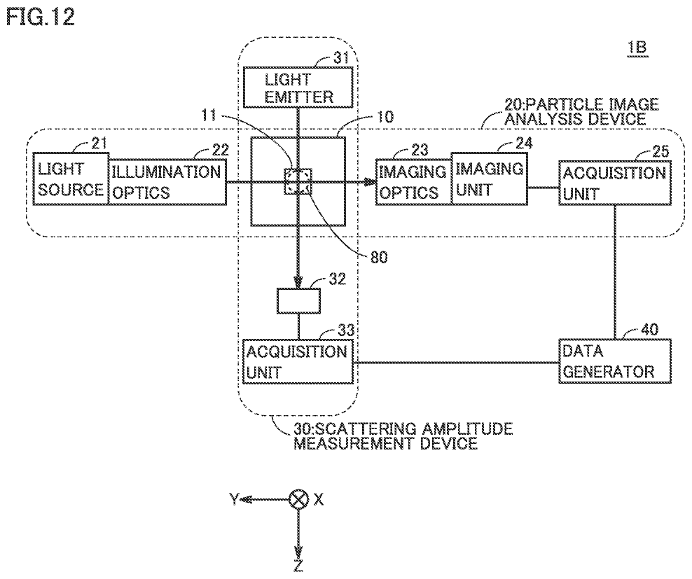

FIG. 12 is a schematic view showing a configuration of an analyzer according to Embodiment 3. FIG. 12 shows an analyzer 1B as viewed in the direction in which a flow channel 11 extends (X-axis direction). As shown in FIG. 12, the analyzer 1B according to Embodiment 3 has the same apparatus configuration as the analyzer 1 shown in FIG. 7, except that a region to be imaged by an imaging unit 24 and a region to which laser light is emitted by a light emitter 31 overlap with each other in the flow channel 11.

Specifically, as shown in FIG. 12, the imaging unit 24 captures an image of a region 80 of the flow channel 11. Laser light is emitted to the region 80, provided that the optical axis of the imaging unit 24 intersects with the optical axis of the laser light. In the example shown in FIG. 12, the optical axis of the imaging unit 24 and the optical axis of the laser light are orthogonal to each other.

According to the analyzer 1B of Embodiment 3, analysis data and a complex individually scattering amplitude S of the same particle 60 can be obtained at the same time. Consequently, there is no need to extract the analysis data and the complex scattering amplitude S from the acquisition unit 25 and the acquisition unit 33, using the time gap between the time t1 indicated by the first time data and the time t2 indicated by the second time data, as the analyzer 1 according to Embodiment 1.

According to the analyzer 1B of Embodiment 3, the orientation of a particle 60 in the image captured by the imaging unit 24 does not coincide with the orientation of the particle 60 as viewed by a photodetector 32. As described above, if the particle 60 has a spherical shape, changes in orientation of the particle 60 has little effect on the obtained analysis data and complex scattering amplitude S. Therefore, the analyzer 1B according to Embodiment 3 is applicable to the particle 60 having a spherical shape.

[Variation]

In Embodiments 1, 2, the particle image analysis device 20 is disposed upper stream of the flow channels 11, 11A than the scattering amplitude measurement device 30. However, the particle image analysis device 20 may be disposed lower stream of the flow channels 11, 11A than the scattering amplitude measurement device 30, in which case, steps S3 through S5 are executed prior to steps S1, S2 in FIG. 10.

The liquid sample may flow through the flow channels 11, 11A in the vertically upward direction. The directions in which the flow channels 11, 11A extend are not limited to the vertical direction, and may be the horizontal direction.

In the above description, the particle image analysis device 20 includes the light source 21, the illumination optics 22, and the imaging optics 23. However, any of the light source 21, the illumination optics 22, and the imaging optics 23 may be omitted, depending on the lighting environment external to the particle image analysis device 20.

In the above description, the data generator 40 uses the analysis data and the complex scattering amplitude S to generate the characteristics data which includes the complex refractive index m of the particle 60. However, the characteristics data may include the complex dielectric constant of the particle 60, in addition to or instead of the complex refractive index m. The complex refractive index m is converted into the complex dielectric constant.

Alternatively, the data generator 40 may generate characteristics data that includes data which is derived from the complex refractive index m or the complex dielectric constant. For example, the data generator 40 pre-stores a table in which a complex refractive index of particle and a composition of the particle are associated with each other. The data generator 40 reads from the table a composition of the particle corresponding to the complex refractive index m calculated as the above. The data generator 40 may then generate characteristics data that includes the composition read from the table.

[Aspects]

The exemplary embodiments and variations thereof described above are understood by a person skilled in the art, as specific examples of the following aspects:

(Item 1) An analyzer (1, 1A, 1B) according to one aspect analyzes characteristics of a particle (60). The analyzer includes a flow channel (11, 11A) through which the particle flows, a particle image analysis device (20), a scattering amplitude measurement device (30), and an data generator (40). The particle image analysis device includes an imaging unit (24) that captures an image of the particle flowing through the flow channel, and a first acquisition unit (25) which obtains, based on the image, a size of the particle captured in the image. The scattering amplitude measurement device includes a laser light source (31, 101) which emits laser light to the flow channel, a photodetector (32) which detects transmitted light, which is a portion of the laser light which has been transmitted through the flow channel, and scattered light caused by the particle flowing through the flow channel, and a second acquisition unit (33) which obtains a complex scattering amplitude of the particle flowing through the flow channel, based on changes over time in interference between the transmitted light and the scattered light. The data generator generates characteristics data, using the size of the particle obtained by the first acquisition unit and the complex scattering amplitude of the particle obtained by the second acquisition unit, the characteristics data including at least one of: a complex refractive index of the particle; a complex dielectric constant of the particle; and any data derived from the complex refractive index or the complex dielectric constant.

According to the above configuration, characteristics of the particle can accurately be analyzed by using not only the complex scattering amplitude measured by the scattering amplitude measurement device, but also the size of the particle obtained by the particle image analysis device.

(Item 2) In the analyzer according to Item 1, the imaging unit captures an image of a first region of the flow channel. The laser light is emitted to a second region of the flow channel. The data generator uses the size of the particle obtained based on the image captured at a first time, and the complex scattering amplitude that is obtained based on the changes over time in the interference in a time period which includes a second time, to generate the characteristics data. A difference between (i) a time gap between the first time and the second time and (ii) a transit time of the particle from the first region to the second region is less than a predetermined threshold.

According to the above configuration, by taking into account the transit time from the first region to the second region, characteristics data can be generated for the same particle using the size and complex scattering amplitude of the same particle.

(Item 3) In the analyzer according to Item 2, the flow channel is linear and has a certain cross-sectional area between the first region and the second region. The imaging unit has a first optical axis and the laser light has a second optical axis, the first optical axis and the second optical axis being in parallel with each other.

According to the above configuration, the analysis data and the complex scattering amplitude can be obtained from particles having the same orientation even if they are close to a spheroid. As a result, characteristics of the particle can be analyzed more accurately.

(Item 4) In the analyzer according to Item 3, the second acquisition unit obtains the complex scattering amplitude of the particle flowing through the flow channel within a target range in the flow channel on an axis that is orthogonal to both the second optical axis and a direction in which the flow channel extends. The first acquisition unit obtains the size of the particle that is captured in a portion of the image corresponding to the target range.

According to the above configuration, even if a region through which the particle, whose complex scattering amplitude is to be measured, passes through a portion of the cross section of the flow channel, the size of the particle, whose complex scattering amplitude has been measured, can be obtained based on the image. This allows analysis on characteristics of the particle with more accuracy.

(Item 5) In the analyzer according to any of Items 1 to 4, the first acquisition unit further obtains, based on the image, a shape of the particle captured in the image. The data generator further uses the shape of the particle obtained by the first acquisition unit, to generate the characteristics data.

According to the above configuration, even if the shape of the particle is unknown, characteristics of the particle can be accurately analyzed.

(Item 6) In the analyzer according to Item 1, the imaging unit captures an image of a target region of the flow channel. The laser light is emitted to the target region. The imaging unit has a first optical axis and the laser light has a second optical axis, the first optical axis and the second optical axis intersecting with each other.

According to the above configuration, the analysis data and complex scattering amplitude of the same particle can be obtained at the same time.

(Item 7) In the analyzer according to any of Items 1, 2, and 6, the photodetector has a first light receiving element (104), a second light receiving element (105), a third light receiving element (106), and a fourth light receiving element (107). The first light receiving element and the third light receiving element are disposed plane symmetric to each other relative to a first plane which includes an optical axis of the laser light and is orthogonal to a direction in which the flow channel extends. The second light receiving element and the fourth light receiving element are disposed plane symmetric to each other relative to the first plane. The first light receiving element and the second light receiving element are disposed plane symmetric to each other relative to a second plane which includes the optical axis of the laser light and is in parallel with the direction in which the flow channel extends. The third light receiving element and the fourth light receiving element are disposed plane symmetric to each other relative to the second plane.

According to the above configuration, the output values of the first light receiving element, the second light receiving element, the third light receiving element, and the fourth light receiving element (i.e., detection values of the transmitted light and the scattered light) depend on the particle position. Thus, the complex scattering amplitude of the particle can be readily calculated by using the changes, over time associated with the movement of the particle, in output value of the first light receiving element, the second light receiving element, the third light receiving element, and the fourth light receiving element.

(Item 8) In the analyzer according to any of Items 1 to 7, the scattering amplitude measurement device further includes a lens (31, 102) which focuses the laser light onto the flow channel.

According to the above configuration, since the laser light is focused onto the flow channel, the output values of the photodetector increases, resulting in improved accuracy in calculation of the complex scattering amplitude.

(Item 9) An analysis method according to one aspect analyzes characteristics of a particle. The analysis method includes: capturing an image of the particle flowing through a flow channel; obtaining, based on the image, a size of the particle captured in the image; emitting laser light to the flow channel; detecting transmitted light, which is a portion of the laser light which has been transmitted through the flow channel, and scattered light caused by the particle flowing through the flow channel; obtaining a complex scattering amplitude of the particle flowing through the flow channel, based on changes over time in interference between the transmitted light and the scattered light; and generating characteristics data, using the obtained size and the obtained complex scattering amplitude, the characteristics data including at least one of: a complex dielectric constant of the particle; a complex refractive index of the particle; and any data that is derived from the complex dielectric constant or the complex refractive index. Also with the above configuration, characteristics of the particle can be accurately analyzed.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An analyzer for analyzing characteristics of a particle, the analyzer comprising:
a flow channel through which the particle is to flow;
a particle image analysis device;
a scattering amplitude measurement device; and
a data generator, wherein
the particle image analysis device includes:
an imaging unit that captures an image of the particle flowing through the flow channel; and
a first acquisition unit which obtains, based on the image, a size of the particle captured in the image,
the scattering amplitude measurement device includes:
a laser light source which emits laser light to the flow channel;
a photodetector which detects transmitted light, which is a portion of the laser light and has been transmitted through the flow channel, and scattered light caused by the particle flowing through the flow channel; and
a second acquisition unit which obtains a complex scattering amplitude of the particle flowing through the flow channel, based on changes over time in interference data, the interference being generated between the transmitted light and the scattered light, wherein
the data generator generates characteristics data, using the size of the particle obtained by the first acquisition unit and the complex scattering amplitude of the particle obtained by the second acquisition unit, the characteristics data including at least one of: a complex refractive index of the particle; a complex dielectric constant of the particle; and any data derived from the complex refractive index or the complex dielectric constant.

2. The analyzer according to claim 1, wherein
the imaging unit captures an image of a first region of the flow channel,
the laser light is emitted to a second region of the flow channel,
the data generator uses the size of the particle obtained based on the image captured at a first time, and the complex scattering amplitude that is obtained based on the changes over time in the interference in a time period which includes a second time, to generate the characteristics data, and
a difference between (i) a time gap between the first time and the second time and (ii) a transit time of the particle between the first region and the second region is less than a predetermined threshold.

3. The analyzer according to claim 2, wherein
the flow channel is linear and has a certain cross-sectional area between the first region and the second region, and
the imaging unit has a first optical axis and the laser light has a second optical axis, the first optical axis and the second optical axis being in parallel with each other.

4. The analyzer according to claim 3, wherein
the second acquisition unit obtains the complex scattering amplitude of the particle flowing through the flow channel within a target range in the flow channel on an axis that is orthogonal to both the second optical axis and a direction in which the flow channel extends, and
the first acquisition unit obtains the size of the particle that is captured in a portion of the image corresponding to the target range.

5. The analyzer according to claim 1, wherein
the first acquisition unit further obtains, based on the image, a shape of the particle captured in the image, and
the data generator further uses the shape of the particle obtained by the first acquisition unit, to generate the characteristics data.

6. The analyzer according to claim 1, wherein
the imaging unit captures an image of a target region of the flow channel,
the laser light is emitted to the target region, and
the imaging unit has a first optical axis and the laser light has a second optical axis, the first optical axis and the second optical axis intersecting with each other.

7. The analyzer according to claim 1, wherein
the photodetector has a first light receiving element, a second light receiving element, a third light receiving element, and a fourth light receiving element,
the first light receiving element and the third light receiving element are disposed plane symmetric to each other relative to a first plane which includes an optical axis of the laser light and is orthogonal to a direction in which the flow channel extends,
the second light receiving element and the fourth light receiving element are disposed plane symmetric to each other relative to the first plane,
the first light receiving element and the second light receiving element are disposed plane symmetric to each other relative to a second plane which includes the optical axis of the laser light and is in parallel with the direction in which the flow channel extends, and
the third light receiving element and the fourth light receiving element are disposed plane symmetric to each other relative to the second plane.

8. The analyzer according to claim 1, wherein
the scattering amplitude measurement device further includes a lens which focuses the laser light onto the flow channel.

9. An analysis method for analyzing characteristics of a particle, the method comprising:
capturing an image of the particle flowing through a flow channel;
obtaining, based on the image, a size of the particle captured in the image;
emitting laser light to the flow channel;
detecting transmitted light, which is a portion of the laser light which has been transmitted through the flow channel, and scattered light caused by the particle flowing through the flow channel;
obtaining a complex scattering amplitude of the particle flowing through the flow channel, based on changes over time in interference between the transmitted light and the scattered light; and
generating characteristics data, using the obtained size and the obtained complex scattering amplitude, the characteristics data including at least one of: a complex refractive index of the particle; a complex dielectric constant of the particle; and any data that is derived from the complex refractive index or the complex dielectric constant.
